(19) United States
(12) Patent Application Publication
(10) Pub. No.: US 2008/0003416 A1
(43) Pub. Date: Jan. 3, 2008

(54) Decorative Articles for Automotive Glazing and Methods of Making the Same

(76) Inventors: Rodney B. Watson, Northville, MI (US); Kevin S. Carney, Farmington Hills, MI (US); Helmut D. Klassen, Virgil (CA); Bernard Weidl, Novi, MI (US); Steven D. Smith, Lebanon, TN (US)

Correspondence Address: AUTOMOTIVE COMPONENTS HOLDINGS LLC;C/O MACMILLAN, SOBANSKI & TODD, LLC, ONE MARITIME PLAZA, FIFTH FLOOR, 720 WATER STREET, TOLEDO, OH, 43604-1853, US

(21) Appl. No.: 11/855,289

(22) Filed: Sep. 14, 2007

Related U.S. Application Data
(63) Continuation-in-part of application No. 11/039,291, filed on Jan. 19, 2005.

(51) Int. Cl. B32B 18/00; B05D 5/06

(52) U.S. Cl. 428/210; 427/163.1

(57) ABSTRACT

A decorative article is provided for an automotive glazing. The decorative article includes an interior layer and an exterior layer in side by side relationship with the interior layer. A vinyl layer is disposed between the interior layer and the exterior layer. A decorative pattern is disposed on a surface of one of the interior layer, the exterior layer, or the vinyl layer. A ceramic pattern layer is disposed inward with respect to the decorative pattern layer. An albedo of the ceramic pattern layer is greater than an albedo of the decorative pattern for providing an enhanced illuminated background of the decorative pattern.

### CROSS-REFERENCE TO RELATED APPLICATIONS

This application is a continuation-in-part of application Ser. No. 11/039,291 filed Jan. 19, 2005.

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM LISTING COMPACT DISC APPENDIX

Not Applicable

### BACKGROUND OF THE INVENTION

1. Field of Invention

The present invention relates to decorative articles and methods of making a reflective background for decorative articles using ceramic frits.

2. Background of Related Art

Ceramic frits have been applied to automotive glazing such as windshields, body glass, backlites, moonroofs, or sunroofs for a variety of purposes. For example, the ceramic coating can block partially or entirely the passage of light through the automotive glazing or a portion thereof, or can impart a color to the glass pane for decorative, aesthetic or functional purposes. The ceramic coating may be conductive to allow it to be used, for example, in conjunction with a defroster or window-heating unit. Ceramic frits are also used in vehicles to protect the adhesive that holds the glass in place from the ultraviolet rays of the sun, to hide electrical wires and other hardware behind the glass, as well as to provide a filter for the amount of sunlight allowed into the vehicle, i.e., “half tones” on the moonroof and certain backlites. Further purposes include using the ceramic frits to obscure a body opening, to block ultraviolet or infrared rays, as well as providing graphic patterns to the vehicle.

Any graphic pattern applied to the automotive glazing is visible from the exterior of the vehicle from two different light sources. One is the light source from the exterior of the vehicle that is reflected from the graphic pattern or from one or more of the glass's surfaces. The other is light rays from the interior of the vehicle that pass through to the exterior. Because of the relatively dark interior of most vehicles, the predominant source of light usually comes from the exterior. As a result, the graphic pattern undesirably appears unclear and muted, with a lack of definition of the graphic pattern.

### BRIEF SUMMARY OF THE INVENTION

This invention generally provides a decorative article on automotive glazing with improved clarity. This result is accomplished by adding a pattern of ceramic frits to provide a reflective background for illuminating the decorative pattern.

Embodiments of the invention may have one or more of the following advantages. Although numerous shades of ceramic frits are available currently, they are not used to provide a contrasting or reflecting background to a decorative pattern on an automotive glazing. The ceramic pattern layer with a reflecting background provides a contrast for illuminating the decorative patterns of the decorative article. Therefore, the decorative pattern attains an enhanced clarity despite the lack of light source from the interior of a vehicle.

In one aspect of the present invention, a decorative article is provided for an automotive glazing. The decorative article includes an interior layer and an exterior layer in side by side relationship with the interior layer. A vinyl layer is disposed between the interior layer and the exterior layer. A decorative pattern is disposed on a surface of one of the interior layer, the exterior layer, or the vinyl layer. A ceramic pattern layer is disposed inward with respect to the decorative pattern layer. An albedo of the ceramic pattern layer is greater than an albedo of the decorative pattern for providing an enhanced illuminated background of the decorative pattern.

In yet another aspect of the present invention, a method is provided of producing a decorative article for an automotive windshield. The method includes providing an interior layer, an exterior layer, and a vinyl layer having a decorative pattern. A ceramic pattern layer is applied inward of the decorative pattern. The ceramic pattern layer is formed by a dot pattern of ceramic frits. The interior and exterior layers are formed in a side by side relationship. The vinyl layer is disposed between the exterior and interior layers. The ceramic pattern layer has an albedo that is greater than an albedo of the decorative pattern for enhancing illumination of the decorative pattern.

Various objects and advantages of this invention will become apparent to those skilled in the art from the following detailed description of the preferred embodiment, when read in light of the accompanying drawings.

### BRIEF DESCRIPTION OF THE DRAWINGS

FIG. 1 is an environmental view of a vehicle having a windshield with a decorative article in accordance with one embodiment of the present invention.

FIG. 2 is an elevated view of the windshield shown in FIG. 1 having the decorative article.

FIG. 3 is a cross-sectional view of the decorative article of FIG. 2 taken along line 3-3 according to a first preferred embodiment of the present invention.

FIG. 4 is a cross-sectional view of the decorative article of FIG. 2 taken along line 3-3 according to a second preferred embodiment of the present invention.

FIG. 5 is a cross-sectional view of the decorative article of FIG. 2 taken along line 3-3 according to a third preferred embodiment of the present invention.

FIG. 6 is a flow chart depicting one method of making the decorative article in accordance with one example of the present invention.

FIG. 7 is an elevated view of the windshield having the decorative article according to one example of the present invention.

FIG. 8 is an elevated view of the windshield having the decorative article according to another example of the present invention.

### DETAILED DESCRIPTION OF THE PREFERRED EMBODIMENT

Embodiments of the present invention provide a contrasting or reflecting background for decorative graphic patterns on an automotive glazing and methods of making the reflective background. The present invention provides a solution to concerns of visibility and clarity of decorative graphic patterns applied to an automotive glazing. Generally, a ceramic pattern layer is applied to the interior layer of a decorative article to provide a contrasting or reflecting background surface relative to other graphic pattern or styling. As a result, the ceramic pattern provides an enhanced illumination of the decorative pattern of the vinyl layer.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

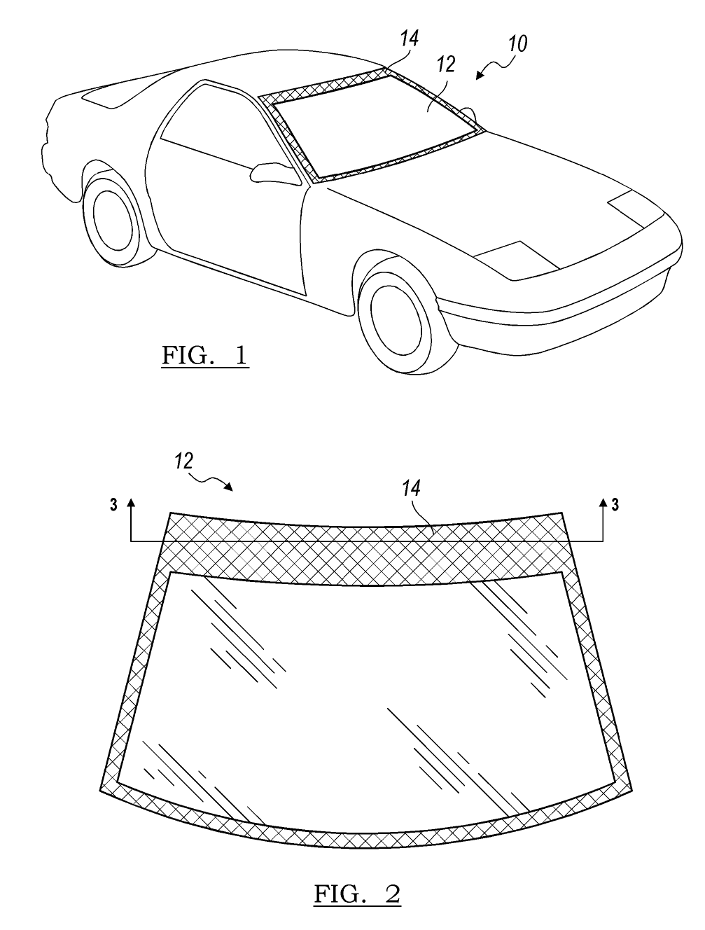

FIG. 1 illustrates a vehicle 10 having a windshield 12 including a decorative article 14 in accordance with one embodiment of the present invention. In this embodiment, the decorative article 14 can be applied to various parts of the automotive vehicle glazing such as the body glass, backlites, moonroofs, or sunroofs and not just limited to the windshield 12 portion of the vehicle.

FIG. 2 depicts the windshield 12 having the decorative article 14 disposed on the windshield 12. As shown, the decorative article 14 is placed on a portion of the windshield 12 configured to avoid reduction of visibility to the driver. It is understood that the article 14 may be disposed on any suitable location on the windshield 12 without falling beyond the scope or spirit of the present invention so long as it does not affect the visibility of the driver.

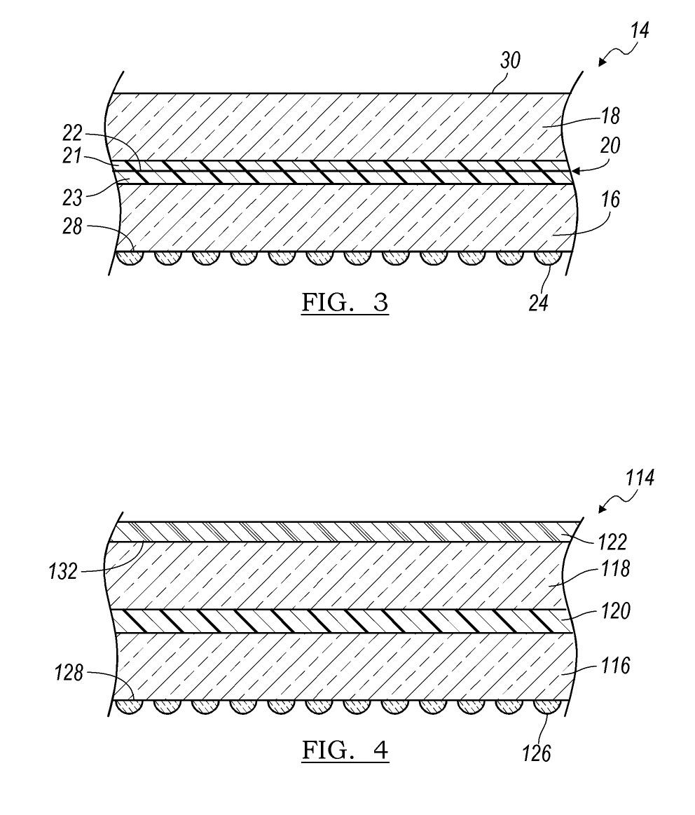

FIG. 3 illustrates a cross-section of one embodiment of the decorative article 14. In this embodiment of the present invention, the decorative article 14 contains an interior layer 16 and an exterior layer 18 aligned in a side by side relationship with one another with a vinyl layer 20 disposed therebetween. The vinyl layer is formed from a first vinyl layer 21 and a second vinyl layer 23. A decorative pattern 22 is disposed between the first vinyl layer 21 and the second vinyl layer 23. The decorative pattern 22 can be any word(s), symbol, picture, or marking, or the decorative pattern 22 can be outlining/border area defining the word(s), symbol, picture, or marking, for example. Pattern 22 is printed on vinyl layers 22 or 23 using UV stable inks.

Suitable material for both the interior layer 16 and the exterior layer 18 include glass and other transparent materials appropriate for use in an automotive windshield 12. The vinyl layer 20 is preferably made from a polyvinyl butyral (PVB) material. Commercially available PVB material for automotive windshield 12 can be obtained from various vendors. Additionally, a printed vinyl layer 20 having a predefined decorative pattern 22 embedded in the PVB material is available from DuPont Corp.

A ceramic pattern layer 24 provides a reflective background for the decorative pattern 22 thereby enhancing the illumination of any of the word(s), symbol, picture, or marking for which the decorative article (14) is illustrating. The ceramic pattern layer 24 is preferably formed by a pattern of ceramic paint containing substantially light reflecting frits. The color of the ceramic pattern layer 24 is preferably white. Alternatively other lighter colors such as beige or tan may be utilized. The albedo (e.g., reflecting power) of the ceramic pattern layer 24 is greater than the albedo of the decorative pattern 22, resulting in improved contrast and visibility of the decorative pattern 22.

As shown in FIG. 3, the ceramic pattern layer 24 is applied to an interior surface 28 of the interior layer 16. Moreover, the ceramic pattern layer 24 is applied in a dot pattern to provide partial transparency through the decorative article 14. The dot pattern can be disposed across the interior layer either evenly spaced from one another or unevenly spaced from one another. Alternatively, the ceramic pattern layer 24 may be applied on the interior surface the windshield to only those areas which do not overlap with the decorative pattern 22.

In one example, the dot pattern may occupy about 40% of the decorative area on which the ceramic pattern layer 24 is applied to the windshield 12. Thus, about 60% of the decorative area is light transparent or open area. However, the decorative area should occupy at least 15% of the dot pattern for the illumination to be effective. This results in a maximum of about 85% light transparency or open area relative to the exterior surface 30. As a result, the ceramic pattern layer 24 provides an enhanced illumination of the decorative pattern 22.

FIG. 4 depicts a cross section of a decorative article 114. In this embodiment, the decorative article 114 includes an interior layer 116, an exterior layer 118, a vinyl layer 120 disposed between the inter layer and the exterior layer 116, and a ceramic pattern layer 126 disposed on the interior surface 128 of the interior layer 116. The decorative article 114 further includes an attachment layer 122 having the decorative pattern.

As shown, the attachment layer 122 is applied to an exterior surface 132 of the exterior layer 118. The attachment layer 122 may be in the form of decals, paint, or appliqués having a respective two-dimensional decorative pattern. The decorative pattern when viewed from the exterior of the vehicle 10 is provided with an enhanced illumination as a result of contrast with the ceramic pattern layer 126.

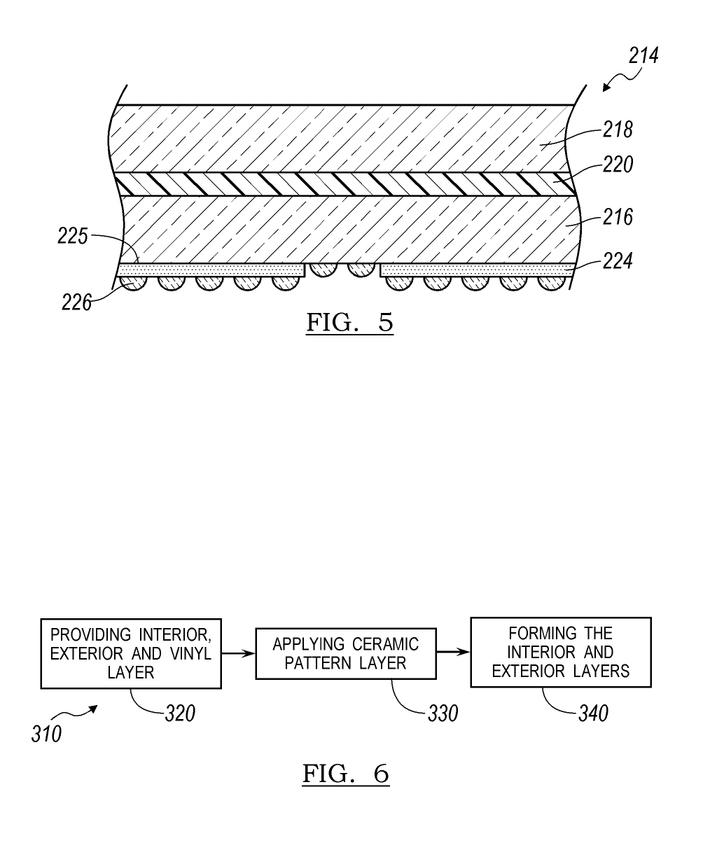

FIG. 5 shows a cross section of yet another embodiment of a decorative article 214. The decorative article 214 includes an interior layer 216, an exterior layer 218, and a vinyl layer 220. The decorative article 214 further includes decorative pattern 224 formed on an interior surface 225 of the interior layer 216. A ceramic pattern layer 226 is disposed on an opposing surface of the decorative pattern 224 thereby being exposed to the interior of the vehicle.

The ceramic pattern layer 226 is preferably formed by a pattern of ceramic paint containing substantially light reflecting frits that are typically white or other light colors with high albedo. The ceramic pattern layer 226 provides a reflective background for the decorative pattern 224. The decorative pattern 224 is preferably light absorbing, e.g., black or other dark colors with low albedo. The decorative pattern 224 is applied to the interior surface 225 of the interior layer 216 in a dot pattern to provide partial transparency through the decorative article 214 so that the ceramic pattern layer 226 may provide enhanced illumination via its light reflective properties.

FIG. 6 illustrates a flowchart of one method 310 of making the decorative article 14 for an automotive glazing in accordance with one example of the present invention. As shown, in the method 310 the interior layer, the exterior layer, and the vinyl layer for the decorative article are provided in step 320. As mentioned above, the interior layer and the exterior layer are preferably made of glass, which is capable of being formed into a predetermined shape at an elevated temperature. The vinyl layer is preferably made of PVB material and may or may not contain any decorative pattern embedded in the PVB material.

In step 330, a ceramic pattern layer is applied to the interior surface of the interior layer of the windshield. The ceramic pattern layer is preferably formed from a ceramic paint containing metal oxides and frits suspended in an organic vehicle. The ceramic frit is a finely ground form of glass binder also known as “flux”. The application of ceramic pattern layer to the interior layer is preferably a screen printing process. Silk-screened decorative glass is fabricated by transferring images or geometric designs to a glass surface. By using the same basic technology as in spandrel glass, the ceramic frit is applied to the glass through a fine mesh screen containing a standard or custom design. Screen printing is a process that allows precise control of the thickness of the mixture deposited and is suitable for mass production. The polyester mesh size of the screen, which controls the thickness of the deposit, is usually 230/inch with thread thickness of about 0.0015″. The higher the mesh count the thinner the deposit. It is also important that the interior surface of the interior layer be clean and dry before the application of the ceramic pattern layer.

In step 340, the interior and exterior layers are formed into a windshield. In this example, the interior and exterior layers are heated to the elevated temperature to soften the glass and to fuse the ceramic paint to the interior layer opposite the vinyl layer. This may be accomplished by setting the interior and exterior layers on metal baskets in contact at the periphery of each layer in a furnace. The furnace is then heated to the elevated temperature. In one embodiment, the elevated temperature is about 1150° Fahrenheit (° F.). At the elevated temperature, the ceramic frit melts and binds the metal oxides while fusing to the interior layer on which it is applied. During heating, the layers drop or sag due to gravity to a desirable shape and contour of the windshield of the vehicle.

In this example, the vinyl layer is then disposed between the exterior and interior layers for adhering the interior layer to the exterior layer. As mentioned above, the vinyl layer preferably includes PVB. The interior and exterior layers are then aligned with each other and pressed or laminated together. The interior and exterior layers with the vinyl interlayer are brought into an autoclaving process for high pressure treatment. For example, the autoclaving temperature may be at about 300° F. and the pressure may be at about 250 pounds per square inch (psi). Of course, other suitable parameters may be used. The vinyl layer serves to bond the interior and exterior layers together.

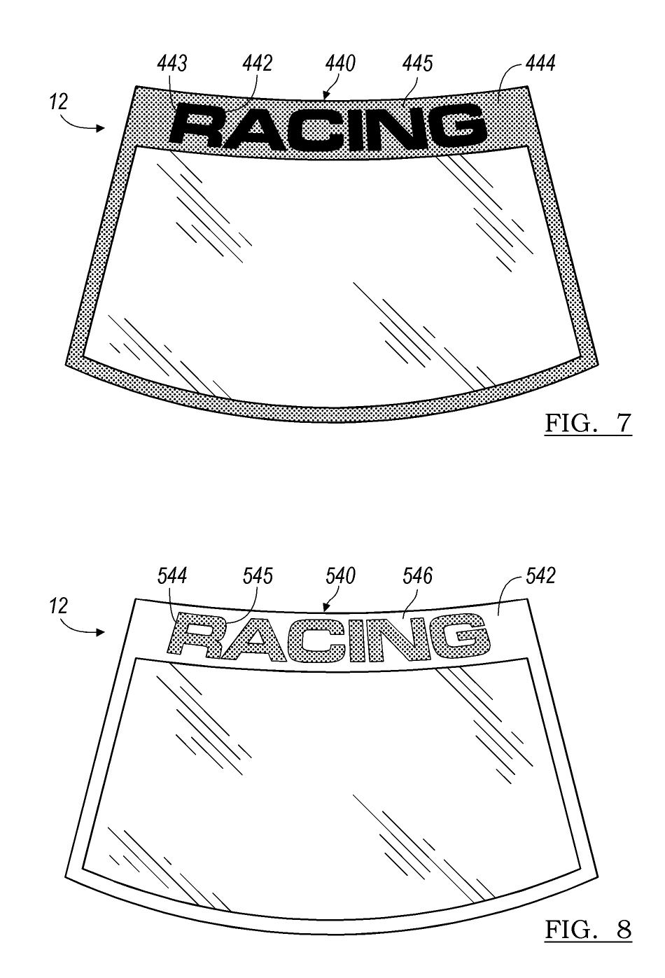

FIG. 7 illustrates a windshield 12 as seen from the vehicle exterior and having a decorative article 440. The decorative article 440 includes a decorative pattern 442 such as the term “RACING”. It should be understood that the decorative pattern 442 can include any word(s), symbol, picture, or marking. The decorative pattern 442 forms a body portion 443 of the decorative article 440. The ceramic pattern layer 444 forms the outlining area 445 (i.e., boundary and outlining area of the decorative pattern). The ceramic pattern layer 444 provides an enhanced illumination background so that the term “RACING” is more distinguishable than if the decorative pattern had been formed on a respective transparent windshield having no reflective (i.e., contrasting) background. The ceramic pattern layer 444 is preferably formed across the entire underlying region of the decorative pattern 442 including its outlining area 445. The decorative pattern 442 is dense such that the portion of the ceramic pattern layer 444 that overlaps with the decorative pattern 442 is not visible from a person viewing the windshield from the exterior of a vehicle. Alternatively, the ceramic pattern layer 444 may be applied on the interior surface of the windshield to only those areas which do not overlap with the decorative pattern 442.

FIG. 8 illustrates a windshield 12 for a decorative article 540. The decorative article 540 is formed by the decorative pattern 542 and the ceramic pattern layer 544 that forms the term “RACING”. A ceramic pattern layer 544 forms a body portion 545 of the term “RACING”. The decorative pattern 542 forms an outlining portion 546 (i.e., boundary area in and about the decorative pattern) of the decorative article 540. It should be understood that the decorative pattern, in this embodiment 542 forms an outline for creating any word(s), symbol, picture, or marking. The ceramic pattern layer 544 enhances the illumination of the actual term “RACING”. That is, the term “RACING” is the reflective portion of the decorative article 540 when viewed by a person positioned exterior to the windshield 12. The decorative pattern 542 which forms the boundary and outlining portion 546 of the term “RACING” is a dense concentration such that the portion of the ceramic pattern layer 544 that overlaps with the decorative pattern 542 is not visible to a person viewing the decorative article 540 from the exterior of the windshield.

While the present invention has been described in terms of preferred embodiments, it will be understood, of course, that the invention is not limited thereto since modifications may be made to those skilled in the art, particularly in light of the foregoing teachings.

What is claimed is:

1. A decorative article for an automotive glazing, the article comprising:
an interior layer;
an exterior layer in side by side relationship with the interior layer;
a vinyl layer disposed between the interior layer and the exterior layer;
a decorative pattern disposed on a surface of one of the interior layer, the exterior layer, or the vinyl layer; and
a ceramic pattern layer disposed inward with respect to the decorative pattern layer;
wherein an albedo of the ceramic pattern layer is greater than an albedo of the decorative pattern for providing an enhanced illuminated background of the decorative pattern.

2. The article of claim 1 wherein the ceramic pattern layer comprises a dot pattern disposed across the interior layer evenly spaced from one another.

3. The article of claim 1 wherein the ceramic pattern layer comprises a dot pattern disposed across the interior layer unevenly spaced from one another.

4. The article of claim 1 wherein the enhanced ceramic pattern layer comprises white dots with between about 40% and 60% dot pattern coverage.

5. The article of claim 1 wherein the ceramic pattern layer comprises white dots with about 40% dot pattern coverage and about 60% open area.

6. The article of claim 1 wherein the decorative pattern is formed in the vinyl layer.

7. The article of claim 5 wherein the vinyl layer includes a first vinyl layer and a second vinyl layer, wherein the decorative pattern is formed on a surface of the first vinyl layer, and wherein the first vinyl layer and the second vinyl layer are integrated together with the decorative pattern disposed therebetween.

8. The article of claim 1 wherein the decorative pattern is formed on an attachment layer that is disposed on an exterior surface of the exterior layer, the decorative pattern being exposed to the exterior.

9. The article of claim 1 wherein the decorative pattern is formed on an interior surface of the interior layer.

10. The article of claim 1 wherein the decorative pattern forms a body portion the article and the ceramic pattern layer forms a border portion for the article.

11. The article of claim 1 wherein the decorative pattern forms a border portion of the article and the ceramic pattern layer forms a body portion of the article.

12. The article of claim 1 wherein the decorative pattern includes light absorbing properties and the ceramic pattern layer includes light reflecting properties.

13. A method of producing a decorative article for an automotive windshield, the method comprising:
providing an interior layer, an exterior layer, and a vinyl layer having a decorative pattern;
applying a ceramic pattern layer inward of the decorative pattern, the ceramic pattern layer being formed by a dot pattern of ceramic frits; and
forming the interior and exterior layers in a side by side relationship, the vinyl layer being disposed between the exterior and interior layers, the ceramic pattern layer having an albedo that is greater than an albedo of the decorative pattern for enhancing illumination of the decorative pattern.

14. The method of claim 13 further comprising the step of forming the decorative pattern on the vinyl layer wherein the vinyl layer includes a first vinyl layer and a second vinyl layer, wherein the decorative pattern is formed on a surface of the first vinyl layer, and wherein the first vinyl layer and the second vinyl layer are integrated together with the decorative pattern disposed therebetween.

15. The method of claim 13 further comprising the step of forming the decorative pattern on an attachment layer, wherein the attachment layer is disposed on an exterior surface of the exterior layer.

16. The method of claim 13 further comprising the step of forming the decorative pattern on an interior surface of the interior layer, the ceramic pattern layer being applied over the decorative pattern.

17. The method of claim 13 wherein the decorative pattern is applied to form a body portion of the decorative article and the ceramic pattern layer is applied to form a border portion for the decorative article.

18. The article of claim 13 wherein the decorative pattern is applied to form a border portion of the decorative article and the ceramic pattern layer is applied to form a body portion for the decorative article.

19. The article of claim 13 wherein the dot pattern of ceramic frits are evenly spaced from one another.

20. The article of claim 13 wherein the dot pattern of ceramic frits are unevenly spaced from one another.
